(19) United States
(12) Patent Application Publication
(10) Pub. No.: US 2009/0217721 A1
(43) Pub. Date: Sep. 3, 2009

(54) Security keyboard cover

(76) Inventor: David Lee, Baltimore, MD (US)

Correspondence Address: David L. Warren, 116 Violet Hill White Way, Baltimore, MD, 21201, US

(21) Appl. No.: 12/232,158

(22) Filed: Sep. 11, 2008

Related U.S. Application Data
(63) Continuation-in-part of application No. 11/506,994, filed on Feb. 1, 2007, now abandoned.

(51) Int. Cl. E05B 9/08

(52) U.S. Cl. 70/450

(57) ABSTRACT

Abstract of the security keyboard cover [to cover your alarm keypad]. When lock it well protect or shied or stop other from play with, programming another [code]. When having a family or group or gathering a holiday, birthday party, vacation and when [someone] is visiting your home [when lock] the security keyboard cover is a proposal for your alarm keypad. This security keyboard cover can be a consideration for a much safer home. This security keyboard cover is being put forward as a counterbalance to advance crime or criminal. This security keyboard cover would draw away the attention of your alarm system. This security keyboard cover is an act of apply or putting or adding or covering over your alarm keypad.

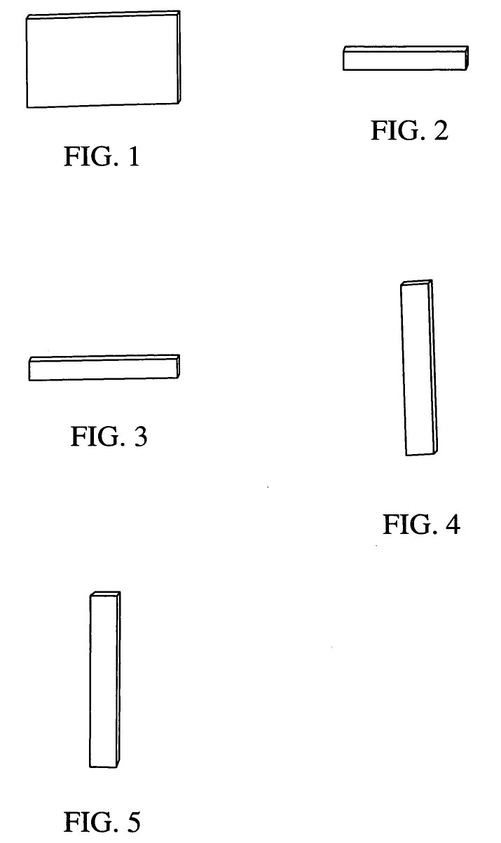

The specification wound give you a detailed of parts and side of material to make the security keyboard cover. It well also specify or state or name parts in detail. This cover could help or hold or keep back a burglar. It could prevent and or stop a burglar from it intension in your dwelling. It could turn aside or away. It could frighten or discourage another with commit a crime. In making this cover the processing is series of action or operation conducing to an end. The security keyboard cover can be make with any material. It can be made with steel, copper, plastic, aluminum and brass material. It can be made to fit all size security keypad. The security keyboard cover come in one united. It is made into one part. It is made to cover your security keyboard or keypad. Security keyboard cover is consist of five parts. The first part is the back. It is made of ⅛″ thick material, the side is 5⅛″ wide and 7¼″ long plate. This is FIG. 1. The second part is the left side ⅛″ thick. The size is 1½″ wide and 7¼″ long plate. This is FIG. 2. The third size is ⅛″ thick. The size is the right side 1½″ wide and 7¼″ long plate this is FIG. 3. The four size is ⅛″ thick. The the size is the bottom the side is 1½″ wide and 5⅛″ long plate, this is FIG. 4. The fifth size is the top. It is ⅛″ thick. The side is 1½″ wide and 5⅛″ long plate. The six step is to tack or spot weld the hasp in the center of the security keyboard cover top or bottom. When assemble 2½″ safety hasp in center of security keyboard cover, the safety hasp to be bend on a 90 degree angle before tack or soot weld and install. Tack or spot weld hinge on other side of hasp.

### BACKGROUND OF INVENTION

The security keyboard cover is to achieve or reach a the safety of your home and family. To let your security company receive a signal. Security keyboard fits over your [alarm keypad] the security keyboard cover was made to achieve or reach a safer home or a secure home environment along with or to you alarm keypad.

### BRIEF SUMMARY OF THE INVENTION

The security keyboard cover can be use in respect to the essential safety to your alarm keypad and also to your home and family.

### SUMMARY

Security keyboard cover fit over all [alarm keypad] it can be made to fit. It allow, or [admits] or [permits] your alarm company to receive a signal when away.

### BRIEF DESCRIPTION OF THE SEVERAL VIEWS OF THE DRAWING

Security keyboard cover is consist of five part. The first one part is the back. The back is a ⅛″ thick plate size is 5⅛″ wide by 7¼″. In FIG. 1.

### BRIEF DESCRIPTION OF THE SEVERAL VIEWS OF THE DRAWING

Security keyboard cover is consist of five part. The second part is [FIG. 2], the side. The left side plate. The left side plate is a ⅛″ thick plate. The plate side is 1½″ wide by 7¼″. In FIG. 2.

### BRIEF DESCRIPTION OF THE SEVERAL VIEWS OF THE DRAWING

Security keyboard cover is consist of five part. The third part is [FIG. 3], the side. The right side plate. The right side plate is a ⅛″ thick plate. The plate side is 1½″ wide by 7¼″. In FIG. 3.

### BRIEF DESCRIPTION OF THE SEVERAL VIEWS OF THE DRAWING

Security keyboard cover is consist of five part. The four part is [FIG. 4], the bottom side. The bottom side plate. The bottom side plate is a ⅛″ thick plate. The plate side is 1½″ wide by 5⅛″. In FIG. 4.

### BRIEF DESCRIPTION OF THE SEVERAL VIEWS OF THE DRAWING

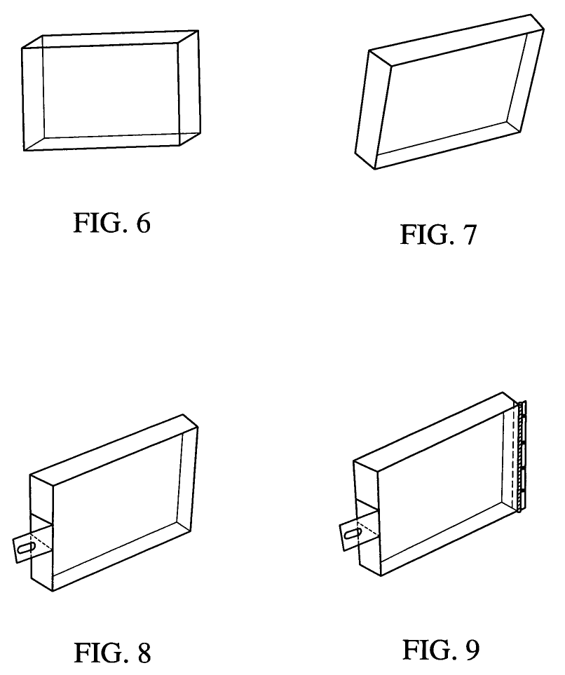

Security keyboard cover is consist of five part. The fifth part is [FIG. 5], the top side. The top side plate. The top side plate is a ⅛″ thick plate. The plate side is 1½″ wide by 5⅛″. In FIG. 5.

### BRIEF DESCRIPTION OF THE SEVERAL VIEWS OF THE DRAWING

1 security keyboard cover fronted view. In [FIG. 6] give you fronted view of cover is assemble or put together.

### BRIEF DESCRIPTION OF THE SEVERAL VIEWS OF THE DRAWING

2 security keyboard cover side view. In [FIG. 7] give you side view of cover is assemble or put together.

### BRIEF DESCRIPTION OF THE SEVERAL VIEWS OF THE DRAWING

3 security keyboard cover side view. In [FIG. 8] give you side view of cover when assemble or put together with hasp.

### BRIEF DESCRIPTION OF THE SEVERAL VIEWS OF THE DRAWING

4 security keyboard cover side view of the inside of the cover. In [FIG. 9] give you side view of cover when assemble or put together with hasp and hinge.

### BRIEF DESCRIPTION OF THE SEVERAL VIEWS OF THE DRAWING

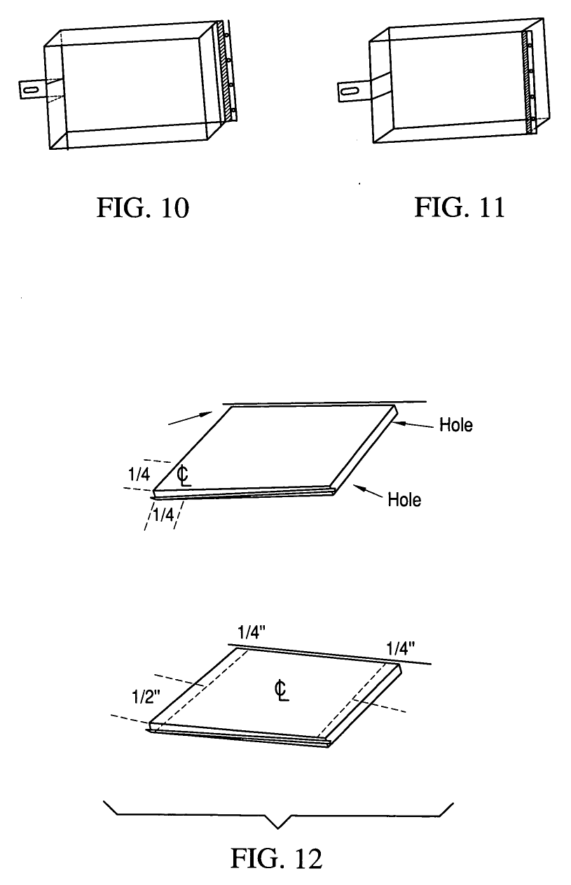

5 security keyboard cover fronted view. In [FIG. 10] give you fronted view of cover when assemble or put together with hasp and hinge. When cover is close.

### BRIEF DESCRIPTION OF THE SEVERAL VIEWS OF THE DRAWING

6 security keyboard cover back view. In [FIG. 11] give you back view of cover when assemble or put together with hasp and hinge. When cover is open.

### BRIEF DESCRIPTION OF THE SEVERAL VIEWS OF THE DRAWING

7 security keyboard cover locking eye. Locking eye is a ⅛″ thick plate. The plate size is 1″×1″×⅛″. Drill 4 holes in plate from each corner ¼″×¼″ center. In FIG. 12.

### BRIEF DESCRIPTION OF THE SEVERAL VIEWS OF THE DRAWING

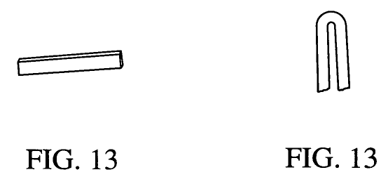

8 security keyboard cover locking eye. Locking eye is also consisted of a 3/16″×2″ rod, that make the locking eye. Bent rod in center with a ⅜″ opening at top and bottom. In FIG. 13.

### BRIEF DESCRIPTION OF THE SEVERAL VIEWS OF THE DRAWING

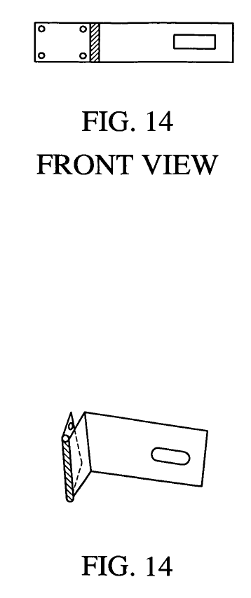

10 security keyboard cover. SAFETY HASP, the safety hasp to be bend on a 90 degree angle before install to the cover. Tack or spot weld the hasp to the center of the security keyboard cover. In FIG. 14.

### BRIEF DESCRIPTION OF THE SEVERAL VIEWS OF THE DRAWING

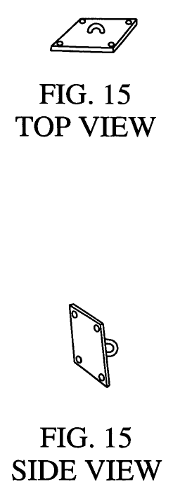

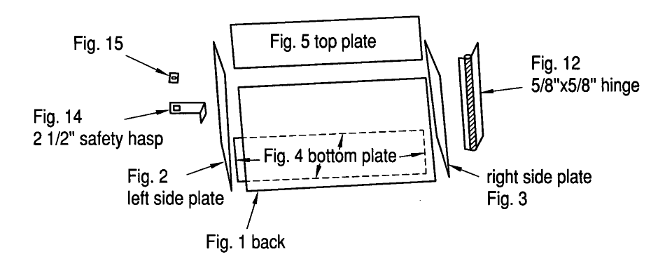

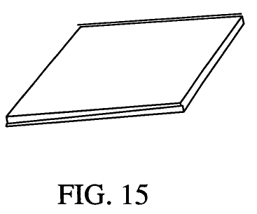

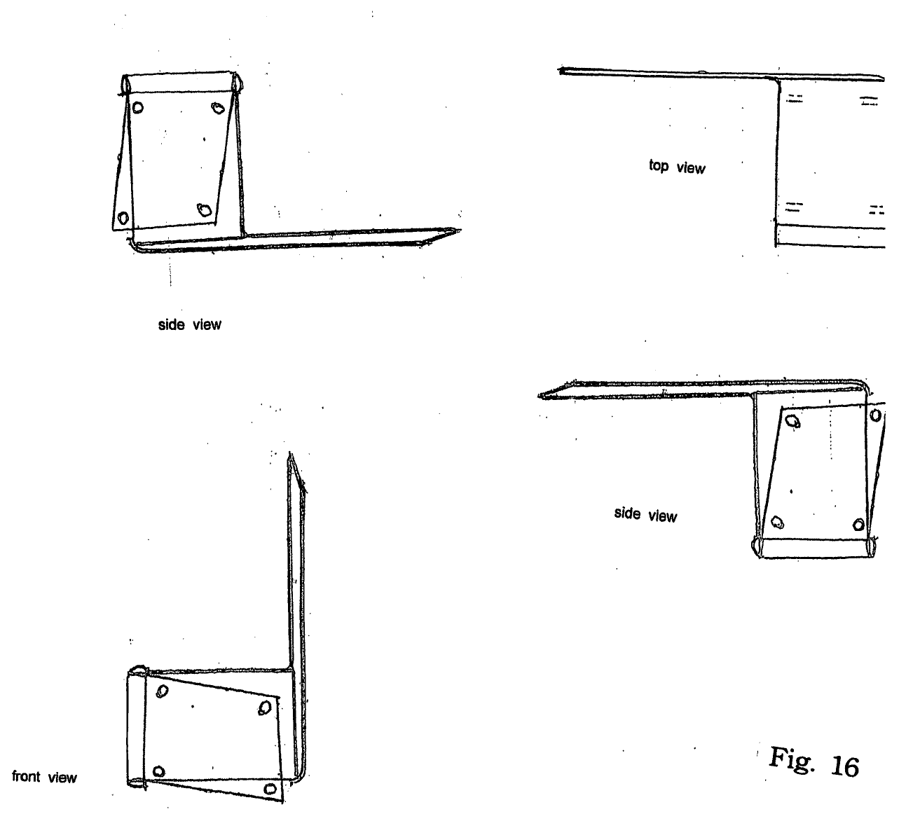

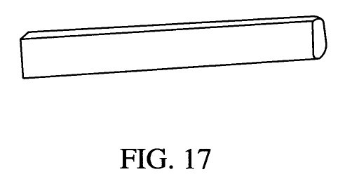

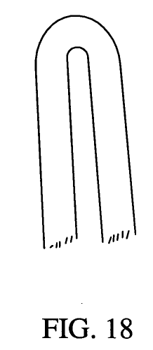

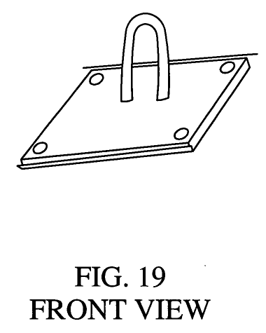

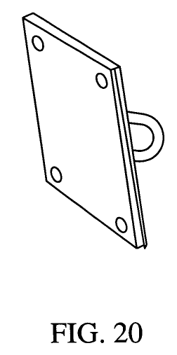

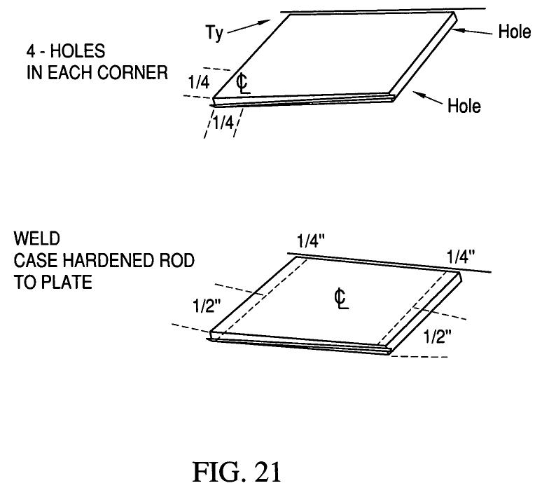

9 security keyboard cover locking eye. Weld bottom of rod to 1″×1″⅛″ to or in center of plate in FIG. 15.

### BRIEF DESCRIPTION OF THE SEVERAL VIEWS OF THE DRAWING

9a security keyboard cover locking eye. Weld bottom of rod to 1″×1″⅛″ to or in center of plate in FIG. 15. FIG. 15 show you top view.

### BRIEF DESCRIPTION OF THE SEVERAL VIEWS OF THE DRAWING

9ab security keyboard cover locking eye. Weld bottom of rod to 1″×1″⅛″ to or in center of plate in [FIG. 15]. [FIG. 15] show you side view.

### BRIEF DESCRIPTION OF THE SEVERAL VIEWS OF THE DRAWING

11 security keyboard cover. On the last page it show each step to assemble or put cover together.

I claim:

1. That this security keyboard cover can be made to fit all particular and normal size alarm keypad. This security keyboard cover protect your home and household from entering or vandalizing your home.
